(19) United States
(12) Patent Application Publication
(10) Pub. No.: US 2026/0270362 A1
(43) Pub. Date: Sep. 10, 2026

(54) METHOD AND SYSTEM FOR EMBELLISHMENT OF PRINTED DOCUMENT

(71) Applicant: Xerox Corporation, Norwalk, CT (US)

(72) Inventors: Steven C. Dianetti, Brighton, NY (US); Kevin Abergel, Melbourne, FL (US); Eric Vessels, Ekron, KY (US); David Parsons, Victor, NY (US)

(21) Appl. No.: 19/559,585

(22) Filed: Mar. 6, 2026

Related U.S. Application Data
(60) Provisional application No. 63/768,708, filed on Mar. 7, 2025.

(51) Int. Cl. H04N 1/60; G06F 16/3332

(52) U.S. Cl. CPC H04N 1/6008; G06F 16/3334

(57) ABSTRACT

Methods and systems for generating documents that are embellished with non-CMYK deposition material are disclosed. The system displays a background image, and it defines an area of the image to which an embellishment will be added. In response to a user input, the system may display an enhanced image that has a representation of the embellishment in the defined area. The system also generates one or more print files configured to cause one or more print devices to print the background image on a substrate with CMYK ink and affix the embellishment to the substrate with the non-CMYK deposition material.

### RELATED APPLICATIONS AND CLAIM OF PRIORITY

This patent document claims priority to U.S. provisional patent application No. 63/768,708, filed Mar. 7, 2025. The disclosure of the priority application is fully incorporated into this document by reference.

### BACKGROUND

The amount of content that is presented to any person on a given day is enormous. Because of the sheer volume of documents, videos, web pages, and other content available for a person to view, the need to generate content that can stand out and capture a person's attention is tremendous.

In the field of physical, printed products, this need is sometimes addressed by embellishing printing documents with unique finishes and textures. However, systems for generating such documents are limited. Some systems apply embellishments with templates, but such systems can only be used with documents that are formatted to accept those templates. Other systems allow users to manually design embellishments, but those systems are expensive, time-consuming, and not efficient. Such systems also are limited to use by individuals who have specialized training, or particular technical and/or design skills.

This document describes methods and systems that address at least some of the issues described above.

### SUMMARY

This document describes methods, systems, and computer program products for applying an embellishment to a printed document. The system will identify an image to be applied to a substrate using cyan, magenta, yellow, and/or black (CMYK) inks to form a printed document. The system will cause a display to output the image. In response to input from a user, the system will define an area of the image to which an embellishment will be added, wherein the embellishment comprises a design to be applied to the printed document using a non-CMYK deposition material. The system will then generate one or more print files containing information that is configured to cause one or more print devices to print the document by affixing the image to the substrate using one or more of the CMYK inks and affixing the embellishment to the substrate using the non-CMYK deposition material. The system will include a processor and a memory with programming instructions. The system also may include a display and one or more print devices.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates example components a print device.

FIG. 2 illustrates elements of an example system for generating and printing embellished documents.

FIG. 3 illustrates, in two images, an example of how the techniques described in this document may transform a standard document into an embellished document.

FIG. 4 illustrates an example process for generating print files for adding an embellishment to a document, and for printing the embellished document.

FIG. 5 illustrates additional details about example print file generation and print file processing methods.

FIG. 6 is a screenshot of an example user interface for document embellishment, which in this instance that is displaying a standard document.

FIG. 7 is a screenshot of the example user interface of FIG. 6, which in this instance is displaying what an embellished document will look like when printed.

FIGS. 8A-8B depict an alternate user interface for document embellishment.

FIG. 9 depicts example hardware components that may be included in any of the electronic devices that are used to implement the methods described in this document.

### DETAILED DESCRIPTION

In this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

Additional terms that are relevant to this disclosure will be defined at the end of this Detailed Description section.

This document describes methods and systems for generating embellishments to be applied to printed documents. As used in this document, the term “embellishment” refers to a feature of the document that is generated with a digital design tool, saved to a print file, and then applied to a printed document using a non-CMYK deposition material. The term “non-CMYK deposition material” means a material that is deposited onto a substrate to yield a printed image that is affixed to the substrate, and that has at least some visual effects that are not accurately reproducible by color print devices that use only standard CMYK (cyan, magenta, yellow, black) color inks or toners. (Note: when this document uses the term “ink”, the term is intended to encompass ink and/or toner unless otherwise stated.) Example non-CMYK deposition materials include specialty inks such as ultraviolet inks, infrared inks, thermochromic inks, and metallic ink compositions that include particles that are metallic or that appear to be metallic. Specialty inks also may include non-CMYK inks and toners (also known as spot colorants) that will provide a specific, accurate color on their own without requiring the addition of any CMYK ink. Non-CMYK deposition materials also include metallic foils, clear coatings, glitter inks, foil inks, puff inks, polymers, and varnishes and other laminates. (While a standard CMYK printer may be able to copy a document that was printed with the non-CMYK deposition material, the copy will not be an accurate copy, as it will not exhibit the non-CMYK effects of the non-CMYK deposition material.)

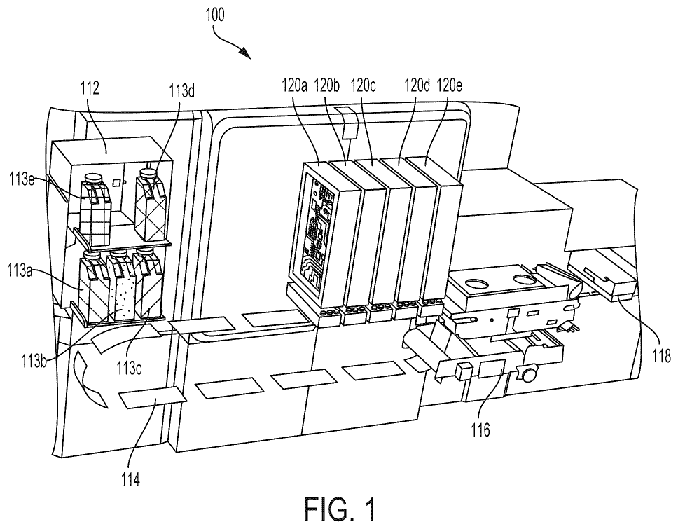

FIG. 1 provides an illustration of components of an example print device 100. As shown, print device 100 includes an ink source 112. In the case of a color printer, the ink source includes at least four ink stations that hold the inks or toners used in a subtractive color model for printing, in particular cyan (C), magenta (M), and yellow (Y), as well as a key (K) which is typically black. In the case of a non-color printer, the ink may be a single color, such as the key or black (K). Such a color model is known as a CMYK color model. A substrate such as paper, enters the print device 100 from a substrate supply and handling subsystem (not shown) and follows substrate path 114. Print device 100 guides the substrate 110 along the substrate path 114 in a direction known as the process direction. The substrate 110 is guided past one or more print assemblies, e.g., 120a-120d, each of which includes a printhead that can apply ink to the substrate 110. The color print device 100 includes at least four print assemblies 120a-120d, one for each CMYK color and key. The print device may include additional substrate handling/management components such as a duplexer 116, which causes the substrate to pass by the printheads 120a-120d a second time, so that the printer assemblies can apply ink to a second side of the substrate. Print device 100 may also include additional processing components, such as a fuser 118 which helps fix the ink to the substrate 110. Print device 100 may have associated software (e.g., driver software) that is configured to control operations of the print device 100 and its components. In some examples, print device 100 includes a controller or processor with embedded software and/or a memory containing programming instructions that is configured to control operations of the print device 100 and its components.

Some printing devices can have one or more additional deposition material stations (e.g., a fifth ink station 112e as in FIG. 1) that can be supplied with a specialty ink or other non-CMYK deposition material that is used in addition to the standard or base colorants that are typically used in print devices (e.g., cyan, magenta, yellow, and black, typically referred to as CMYK, or simply black (K) if the device is a black-and-white printer). Such print devices also may have an additional print assembly 120e for each such ink station. Other print devices may not be supplied with CMYK ink stations but instead may be embellishment machines that are supplied only with non-CMYK deposition materials, such as foiling machines and lamination devices.

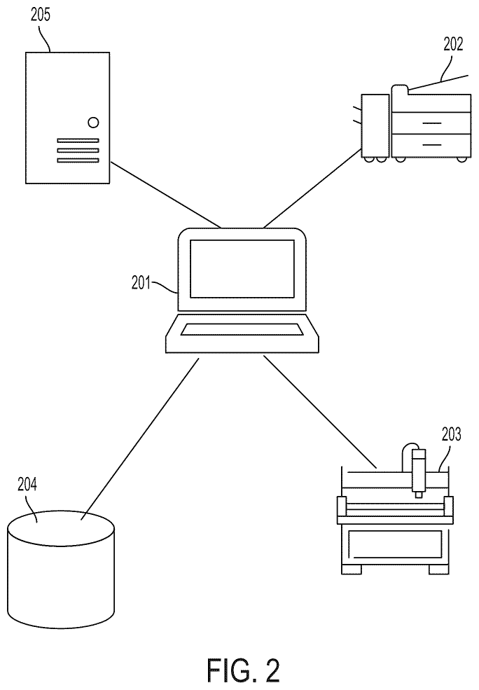

This document describes novel methods and systems for generating a print file that one or more print devices can use to print an embellished document with CMYK ink and non-CMYK deposition material, and for using the print file to print the document. The methods described in this document may employ printers with ink stations and print assemblies for both CMYK inks and non-CMYK deposition materials as shown in FIG. 1. Alternatively, the methods may employ multiple print devices, each of which is capable of applying various deposition materials to substrates. For example, referring to FIG. 2, a system may include a computing device 201 with a processor, user interface, and local or remote instructions that cause the computing device's processor to implement the methods described in this document. The computing device 201 is communicatively connected to a print device 202 and can send print files to the print device 202 to be used in a printing process. The print device 202 may include both one or more CMYK ink stations and one or more non-CMYK deposition material stations, as described above in the discussion of FIG. 1. Alternatively or in addition, the computing device 201 may be communicatively connected to an embellishment device 203, which is a print device, such as a stamping machine or other device, that can apply and affix a non-CMYK deposition material to a substrate to print all or part of the image on the substrate. The computing device also may include or be communicatively connected to one or more databases 204 and one or more artificial intelligence models 205.

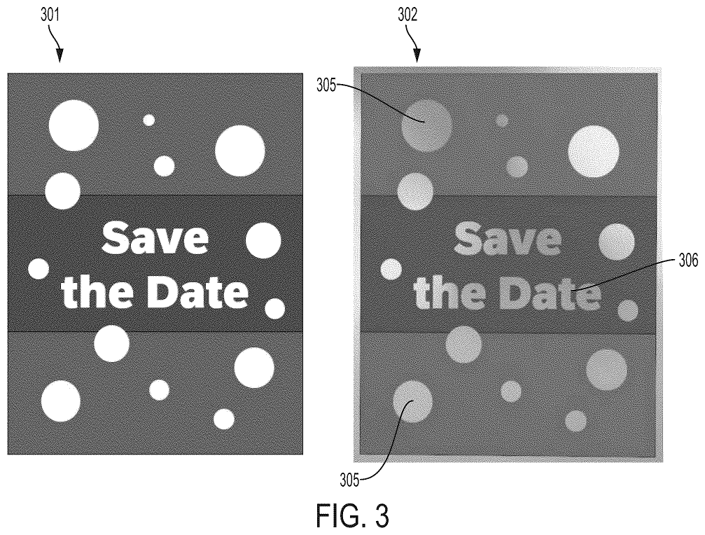

FIG. 3 illustrates an example of a standard document 301 that a print device may print using standard CMYK inks. FIG. 3 also illustrates a variation of the printed document that is an embellished document 302 to which a non-CMYK deposition material has been applied. In this example, a specialty ink that visually appears as gold is printed over the whitest areas of the document, including various sections of the printed artwork 305 and the text 306 of the document.

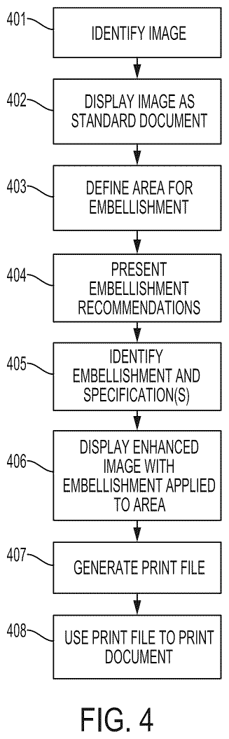

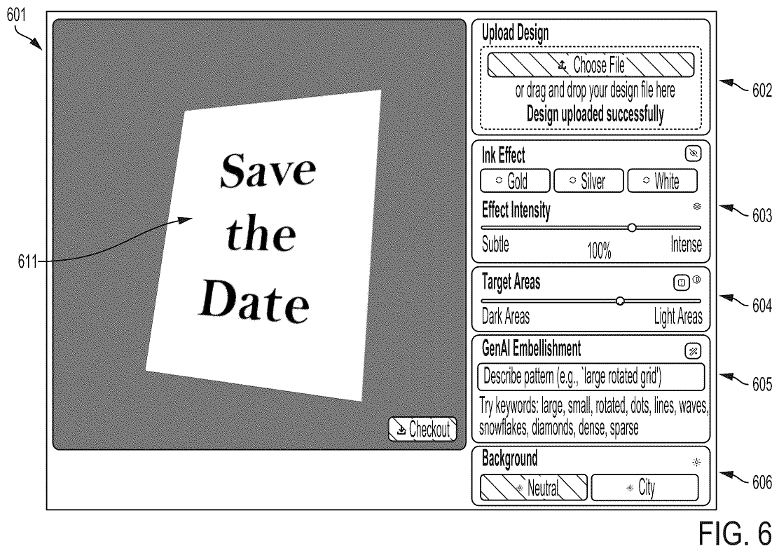

FIG. 4 illustrates an example process for generating a print file that adds an embellishment to a document, and for printing the embellished document. The process may be implemented by a user interface, at least portions of which are displayed on an electronic device. Example user interfaces are illustrated in FIGS. 6, 7 and 8A-8B and will be described below. In the method, at 401 a processor of the system will execute programming instructions that cause the system to identify a primary image to be applied to a substrate using cyan (C), magenta (M), yellow (Y), and/or black (K) inks to form a printed document. The system may identify the image in any number of ways. For example, the system may receive the image from a user by the user uploading an image file to the system via a user interface, such as the image upload field 602 of the user interface 601 of FIG. 6. Alternatively, the system may include or be in communication with an image library or other source of image files, and the system may present the user with candidate images to select in response to prompts or search criteria that the user provided. Alternatively, the system may select a default image, or the system may randomly select an image from an image library.

At 402 the system will cause a display of the user's electronic device to display the image on a display device as a standard document (that is, as it will appear when printed using one or more CMYK inks). This is illustrated by way of example with standard document 411 in the user interface 601 of FIG. 6.

In response to input from a user, at 403 the system will define an area of the image to which an embellishment will be added. At 405 the system will identify one or more specifications for the embellishment. Steps 403 and 405 do not necessarily need to be done in sequence. In various applications, the system may define the area first, identify the embellishment specifications first, or do both concurrently.

The system may define the area to which the embellishment will be added in any number of possible ways. For example, the user may select a target area to which to apply the embellishment. This may be done by a target area definition field 604 of a user interface such as that shown in FIG. 6. In the example shown, the target area is defined by the user by selecting a target luminosity value. The target area may then be set to include all pixels of the image that have a luminosity value within a threshold range (such as +/−5% or +/−10%) of the target luminosity value. In FIG. 6, the target area definition field 604 includes a slider bar that a user can actuate to select a particular target luminosity between the brightest and the darkest luminosities.

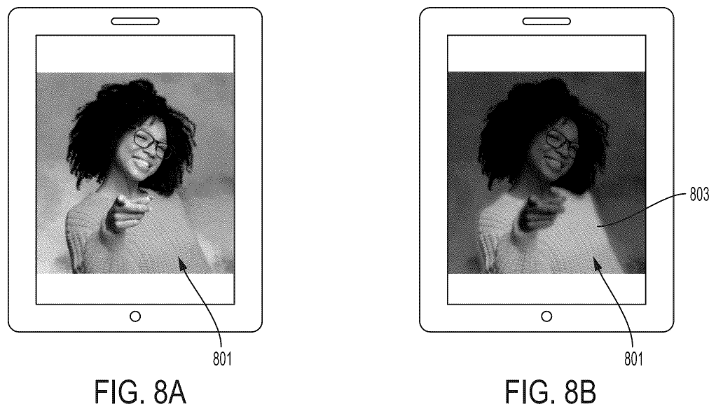

Other methods to define the target area may include processing the image to segment the image into one or more target areas and receiving a selection of one of the target areas. For example, referring to FIGS. 8A-B, the target area 801 is that of a sweater that the woman appearing in the image is wearing. The electronic device may display the image, and the user may select a point in the image by touching or placing a stylus on the sweater via a touchscreen. The system may then use any now or hereafter known image segmentation algorithm to define a boundary 803 around the selected point, such as semantic segmentation, instance segmentation, or panoptic segmentation. Alternatively, the system may pass the image and the selected point to a trained image segmentation model such as Mask-R-CNN or DeepLab. Alternatively, the system may have defined partitions for the image prior to presenting it to the user, and if so the target area may simply be the partition that contains the point that the user selected.

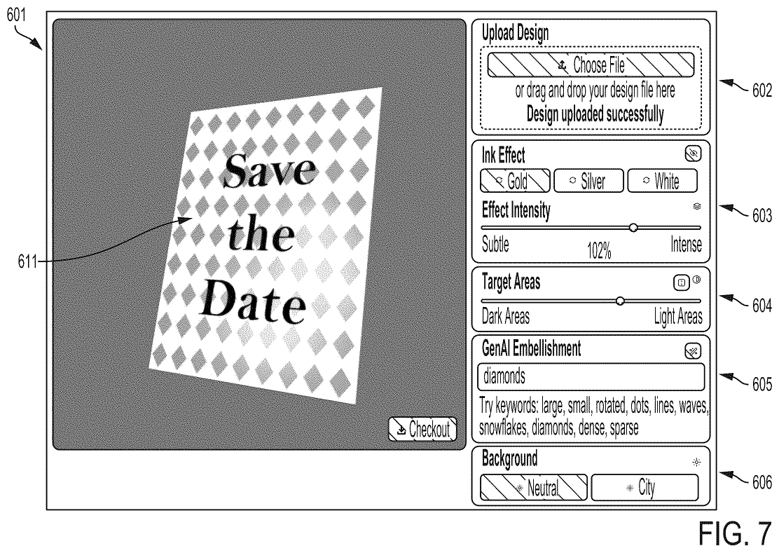

Returning to FIG. 4, optionally at 404 the system may present one or more candidate embellishment specifications to the user. Embellishment specifications may include embellishment types such as particular patterns, designs, or other features to be added to the image. Embellishment specifications also may include characteristics of the non-CMYK deposition material to be used and/or specifications for the application of that material to the substrate such as material, intensity, pile height, and/or other specifications. Referring to FIGS. 6 and 7, the system may present these candidate specifications in user interface fields such as an ink effects field 603, embellishment type field 605, and background effects field 606. Alternatively, or in addition, the system may present the embellishment recommendations to the user via an audio output. Alternatively, in some embodiments the system may not present (or may not need to present) recommendations to the user, and instead the user may enter or speak a text prompt describing the embellishment, and the system may use any known natural language processing (NLP) method to process the text prompt to yield search terms that the system will use to identify one or more available embellishment types and ink specifications that correspond to the text. For example, the system may identify one or more keywords in the text string and use semantic searching to search a data set for embellishment specifications that correspond to the keywords. As another example, the system may input the keywords or the text string into a trained artificial intelligence model to return one the candidate embellishment specifications.

The system may use any number of methods to present the embellishment specifications to the user. For example, the system may store a set of template embellishment types, along with a set of available non-CMYK deposition material types, and it may present those candidates in an ink effects field 603 and embellishment type field 605 (where the embellishment type is a class of embellishment, such as a pattern, template, or other effect.) Alternatively, the system may send the image and/or target area to a trained image classifier to classify the image and/or an object that appears in the target area, and when the system returns a class for the image and/or object the system may select a stored set of embellishment patterns and/or non-CMYK deposition material types that correspond to that class. In some embodiments, the system may apply additional criteria to filter or select embellishment specifications before presenting them to the user. For example, if the system has received information identifying the print devices and/or print device capabilities that the user will use to print the embellished document, the system may limit the embellishment material specifications to the non-CMYK deposition materials that are available in the known print devices.

Returning to FIG. 4, at 405 the system will identify an embellishment type and specifications, such as by receiving a user selection of one or more of the candidate specifications. This is illustrated by way of example in FIG. 7 in which a user has selected an embellishment type that is a pattern overlay of large rotated dots (see pattern overlay field 605), a specialty ink that appears to be silver and that will be applied at a moderately elevated intensity (see ink effects field 603), and a target area that includes all pixels having a low luminosity/dark appearance (see target area definition field 604).

At 406 the system will cause the display to update the image to show the embellishment in the defined area according to the one or more specifications, resulting in an enhanced image. The system may display this according to the user-selected specifications, if presented before this step. Alternatively, the system may simply display the embellishment on the image as a candidate embellishment type and specification that that user may accept or reject.

To display the enhanced image, in some embodiments the system may calculate a red, green, blue (RGB) representation of the non-CMYK deposition material that enables the visual effect of the printed non-CMYK deposition material to be represented on an electronic display device. Any color conversion tool that converts an image from CMYK color space to an RGB color space, such as those available in the Adobe Photoshop™ image editing tool, may be used. Alternatively or in addition, the system may employ other techniques, such as a lookup table that associates known materials and/or material characteristics with RGB values, to identify the RGB values that will be used to generate the displayed image. As yet another alternative, the system may simply render the image using RGB values and determine CMYK and non-CMYK specifications when generating a print file for the document, which will be described below.

The displaying of an enhanced image in step 406 is illustrated by way of example comparing the original image 611 of FIG. 6 with the enhanced image 612 of FIG. 7, as the enhanced image 612 includes an embellishment that is a pattern overlay of diamonds formed of gold foil and applied to the light portions of the image. In another example, FIG. 8A shows an original image with woman's sweater selected as a target area 801, while FIG. 8B is an enhanced image in which an RGB representation of the embellishment has been rendered and displayed in the target area 801.

Returning to FIG. 4, at 407 the system will generate one or more print files containing information that is configured to cause one or more print devices to print the printed document with CMYK ink and the embellishment. The information will identify the pixels or locations on a substrate, typically defined with respect to a reference point such as a corner or center point, as well as instructions for applying deposit material to each location to form an image on the substrate. Instructions may include the specific relative combinations of C, M, Y, and/or K inks and that will be applied to each location, as well as an indication if non-CMYK deposit material is to be applied to a location. The system may do this using any file type containing image that a printer may process to apply the image to a substrate. These include methods by which the system generates a known file type such as PDF, PNG, JPEG, and/or TIFF, or the methods may generate a file type that follows a proprietary or unique protocol. The system may generate a single print file with all information needed to apply both CMYK ink and the non-CMYK deposition material. Alternatively, the system may generate separate print files, including one file with instructions for applying CMYK ink to a substrate and another file with instruction for applying the non-CMYK deposition material to the substrate. If the system has not already defined CMYK specifications for the image, then when generating the print file(s) the system may convert the RGB values of the displayed image to CMYK specifications for use in printing.

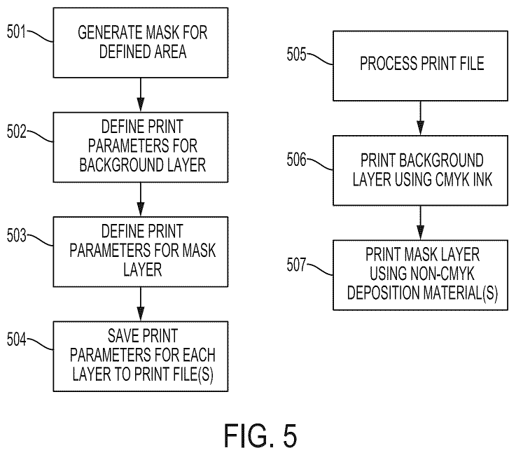

In some embodiments, the system may generate the print file or files using a process such as that of steps 501-504 of FIG. 5. In such a process, when the system defines the area for embellishment (step 403 above), at 501 the system generates a mask for the defined area to which the embellishment is to be applied. The system may use an image segmentation algorithm, or output of an image segmentation algorithm such as those described above. At 502 the system will define the print parameters for the background layer, in which the parameters will include color values and/or other values for pixels to which CMYK ink will be applied. At 503 the system will define the print parameters for the mask layer, with the parameters such as ink type, intensity, and or values for pixels to which a non-CMYK deposition material will be applied. If the print file is of a type that can store data about multiple layers of the image, such as a layered PDF file, then the system may include both layers in a single file. Alternatively, the system may save the different layers to different files, such as by saving the CMYK ink print details to a PDF file for use by a print device, and saving the non-CMYK deposition material print details to a TIFF file for use by an embellishment device.

Optionally, when generating and outputting the print file, the system also may determine whether it knows the deposition materials that are available in the print device or devices that will be used to print the documents. The system may receive this information from user input, from a database, by querying the devices, or by being communicatively connected to those devices. If the system knows from this information that a single device is equipped to apply both the CMYK inks and the non-CMYK deposition materials and will be used to print the document, the system may generate a single print file. If the system cannot confirm that a single print device will be used, the system may generate separate print files for the image layer and embellishment layer, as described above.

Returning again to FIG. 4, if the system that performs the method above is not part of a print device, the system may transfer the resulting print file or files to the print device or devices that will print the document. When a print device has any of the print files, then at 408 the print engine of the print device will process the print file to print one or more layers of the printed document. When printing the document, the system's print device or devices will apply (a) CMYK ink to pixels in which the original image is to appear on the substrate, and (b) non-CMYK deposition material to areas of the substrate in which embellishments are to be applied.

Optionally, if the print file is a layered print file such as that generated by steps 501-504 of FIG. 5, then when printing the document at 408 the system may follow the process of steps 505-507 of FIG. 5, which include processing the print file to extract the print parameters for each layer at 505, printing the background layer (i.e., original document areas) using one or more CMYK inks at 506, and printing the mask layer (i.e., the target areas with embellishment) using one or more non-CMYK deposition materials at 507.

The processes described above can be used to print any type of document, such as a greeting card, a poster, a banner, a label, an invitation, an event ticket, a table card, a mailing, an envelope, a report, a pamphlet, a postcard, or any other document in which content is printed on a substrate. In addition, the processes described above can enable a user to easily create embellishments for documents, and generate print files for those documents, without any requirement that the user have any knowledge of print file specifications, or any particular skill in print file definition. The system can also allow the user to dynamically select and view various candidate embellishments in digital representations that simulate what the embellished documents will look like when printing, thus avoiding the cost, time, and waste material generation that would otherwise be required to print several document variations for review and discarding those that are not desired.

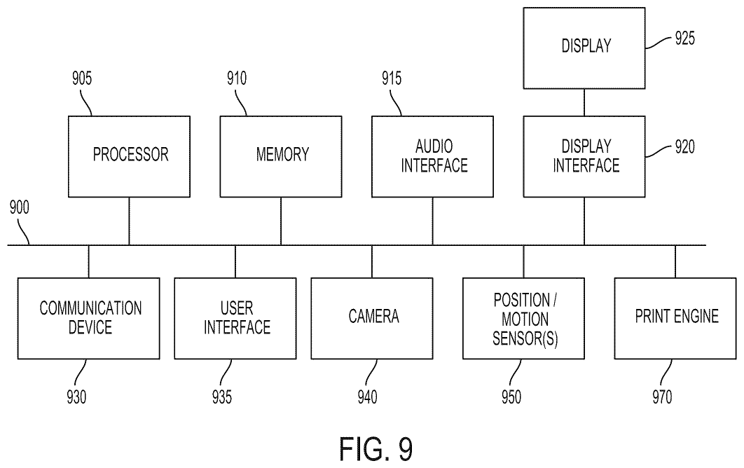

FIG. 9 depicts an example of internal hardware that may be included in any of the electronic components of the system, such as a smartphone, a tablet computing device, a print device, or a local or remote computing device in the system. A conductive path such as a bus 900 serves as a communication path via which messages, instructions, data, or other information may be shared among the other illustrated components of the hardware. Processor 905 is a central processing device of the system, configured to perform calculations and logic operations required to execute programming instructions. Read only memory (ROM), random access memory (RAM), flash memory, hard drives and other devices capable of storing electronic data constitute examples of memory devices 910.

An optional display interface 920 may enable information to be displayed on a display device 925 in visual, graphic or alphanumeric format. The display device may be any suitable display such as an LED or LCD display, a head-up display (as may exist in an augmented reality device), a projector, or other electronic device that is capable of rendering and electronically displaying an image. An audio interface 915 with audio output (such as a speaker) also may be provided.

Communication with external devices may occur using various communication devices 930 such as a wireless antenna, a radio frequency identification (RFID) tag and/or short-range or near-field communication transceiver, each of which may optionally communicatively connect with other components of the device via one or more communication systems. The communication device 930 may be configured to be communicatively connected to a communications network, such as the Internet, a local area network or a cellular telephone data network. The communication device 930 will enable the electronic device to send messages to and receive messages from other electronic devices, such as those that hold data stores, template libraries, or specifications for non-CMYK deposition materials such as specialty inks, as well as those on which trained machine learning models operate.

The hardware may also include a user interface device 935 that includes one or more input devices that can receive data and/or commands from a user. Example user interface devices 935 include a keyboard, a mouse, touchscreen, a touch pad, a remote control, a pointing device, and/or a microphone. A camera 940 may include image sensors and other hardware that can capture video and/or still images.

The system also may include one or more positional and/or motion sensors 950 that can detect position and movement of the device. Examples of motion sensors include gyroscopes, accelerometers, and inertial measurement units (IMUs). Examples of positional sensors include a global positioning system (GPS) sensor device that receives positional data from an external GPS network.

In embodiments where the electronic device is a print device, the hardware also may include a print engine 970 that is configured to apply ink and/or toner to a substrate. Example components of a print engine include a printhead, along with marking material storage and delivery components such as a print cartridge containing ink, toner, or another marking material. A typical print engine also includes conveyors, rollers, and/or other media transport components that are configured to move a substrate past the printhead so that the printhead may print characters and/or images onto various locations of the substrate. In an inkjet printing system, the marking material storage and delivery components may include one or more print heads arranged in an array or other arrangement that eject ink drops onto the substrate. In a laser printer, the marking material storage and delivery components may include toner, a laser, and related components configured to transfer the toner onto the substrate.

Terminology that is relevant to this disclosure includes:

In this document, when terms such as “first” and “second” are used to modify a noun, such use is simply intended to distinguish one item from another and is not intended to require a sequential order unless specifically stated.

The term “approximately” when used in connection with a numeric value, is intended to include values that are close to, but not exactly, the number. For example, in some embodiments, the term “approximately” may include values that are within +/−10 percent (or, in some embodiments, +/−5 percent, +/−3 percent, or +/1 percent) of the value. By way of example, the phrase “approximately 100%” will include values from 90% to 100%, and the phrase “approximately 90 degrees” will include values from 81 degrees to 99 degrees.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual or augmented reality devices, Internet-connected wearables such as smart watches and smart eyewear, personal digital assistants, cameras, tablet computers, laptop computers, media players and the like. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 9.

As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “printer” and “print device” refer to a machine having hardware capable of reading digital data and using the information from the data and associated print instructions to print a physical document by applying ink, toner, or other deposition material on a substrate. In some embodiments, a print device may have additional capabilities such as scanning or faxing and thus may be a multifunction device (MFD). Components of a print device typically include a print engine, as well as a document feeding system configured to pass a substrate through the print device so that the printhead or printheads of the print engine can print characters and/or images on the substrate.

The term “print engine” refers to the marking hardware of a print device, such as a print head, along with marking material storage and delivery components such as a print cartridge containing ink, toner or another deposition material. A print engine also includes conveyors, rollers, or other media transport components that are configured to move a substrate past the print head to receive printed images onto the substrate. The print engine also may include a control system that controls operation of the hardware described above.

The term “classifier” means an automated process by which an artificial intelligence system may assign a label or category to one or more data points. A classifier includes an algorithm that is trained via an automated process such as machine learning. A classifier typically starts with a set of labeled or unlabeled training data and applies one or more algorithms to detect one or more features and/or patterns within data that correspond to various labels or classes. The algorithms may include, without limitation, those as simple as decision trees, as complex as Naïve Bayes classification, and/or intermediate algorithms such as k-nearest neighbor. Classifiers may include artificial neural networks (ANNs), support vector machine classifiers, and/or any of a host of different types of classifiers. Once trained, the classifier may then classify new data points using the knowledge base that it learned during training. The process of training a classifier can evolve over time, as classifiers may be periodically trained on updated data, and they may learn from being provided information about data that they may have mis-classified. A classifier will be implemented by a processor executing programming instructions, and it may operate on large data sets such as image data, LIDAR system data, and/or other data.

The terms “artificial intelligence model” and “AI model” refer to systems that can generate output in response to one or more prompts, other input, or other action without being explicitly programmed or using a rules-based structure to generate its output. Instead, an AI model learns to generate output in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. Examples of AI models include those embodied in neural networks.

An “image segmentation model” is an AI model that has been trained to partition images into segments.

A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems perform various types of statistical analyses, machine learning systems are distinguished from statistical analyses by virtue of the ability to learn without explicit programming and being rooted in computer technology.

“Training” of a machine learning model may include building and/or updating a machine learning model from a sample dataset (referred to as a “training set”), evaluating the model against one or more additional sample datasets (referred to as a “validation set” and/or a “test set”) to decide whether to keep the model and to benchmark how good the model is, and using the model in a production environment to make predictions or decisions, or to generate content, based on new input data.

A text-to-speech (TTS) engine is a system that is programmed to generate audio files from text, thus converting the text to audible sound. In practice, a TTS engine may normalize the raw text to convert any numbers, symbols, or other non-text characters into text. The TTS engine may then assign phonetic transcriptions to each word in the text, which is sometimes referred to as text-to-phoneme conversion. An audio synthesizer will then convert the phonetic transcriptions into sound. Example TTS engines include those known as Natural Reader and Microsoft Narrator.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

Without excluding further possible embodiments, certain example embodiments are summarized in the following clauses:

Clause 1: A method for printing a document with an embellishment comprises, by a processor: (a) identifying an image to be applied to a substrate using cyan, magenta, yellow, and/or black (CMYK) inks to form a printed document; (b) causing a display to output the image; (c) in response to input from a user, defining an area of the image to which an embellishment will be added, wherein the embellishment comprises a design to be applied to the printed document using a non-CMYK deposition material; and (d) generating one or more print files containing information that is configured to cause one or more print devices to print the document by affixing the image to the substrate using one or more of the CMYK inks and affixing the embellishment to the substrate using the non-CMYK deposition material.

Clause 2: The method of clause 1, further comprising, by the one or more print devices upon processing one or more of the print files: using the one or more CMYK inks to affix the image to the substrate; and using the non-CMYK deposition material to affix the embellishment to the substrate.

Clause 3: The method of clause 2, wherein: (a) the one or more print devices comprise a single print device having one or more CMYK ink stations and the non-CMYK deposition material; (b) generating the one or more print files comprises generating a single print file with a first layer containing information that is configured to cause the single print device to print the image and a mask layer containing information that is configured to cause the single print device to print the embellishment; (c) the information that is configured to cause the one or more print devices to use the one or more CMYK inks is in the first layer; and (d) the information that is configured to one or more print devices to use the non-CMYK deposition material is in the mask layer.

Clause 4: The method of clause 2, wherein generating the one or more print files comprises, in response to not confirming that a single print device having one or more CMYK ink stations and the non-CMYK deposition material will be available: (a) generating a first print file containing information that is configured to cause a first print device having one or more CMYK ink stations to print the image on the substrate; and (b) generating a second print file with information that is configured to cause a second print device to affix the non-CMYK deposition material to the substrate.

Clause 5: The method of any preceding clause further comprising, in further response to the user input, causing the display to update the image to output an enhanced image in which a representation of the embellishment is displayed in the defined area according to the selected one or more specifications.

Clause 6: The method of clause 5 further comprising, before causing the display to output the enhanced image, causing the display to output one or more candidate specifications for the embellishment by: (a) sending the image or the area to an image classifier to return a class, (b) identifying one or more specifications that correspond to the class, and (c) outputting the identified one or more specifications as the one or more candidate specifications, and wherein the one or more selected specifications are selected by a user from the one or more candidate specifications.

Clause 7: The method of any preceding clause further comprising, in response to the user input being a text string: processing the text string to identify one or more keywords in the text string; using the one or more keywords to search a set of embellishment specifications and return one or more embellishment specifications that correspond to the one or more keywords; and outputting the returned one or more embellishment specifications as one or more candidate specifications, wherein the returned one or more embellishment specifications are selected by a user from the one or more candidate specifications.

Clause 8: The method of any of clauses 1-6 further comprising, in response to the user input being a text string: inputting the text string or one or more keywords from a text string to a trained artificial intelligence model; and upon receiving one or more embellishment specifications from the model in response to the input, outputting the received one or more embellishment specifications as one or more candidate specifications, wherein the received one or more embellishment specifications are selected by a user from the one or more candidate specifications.

Clause 9: The method of any preceding clause, wherein causing the display to output the image comprises: identifying a red, green, blue (RGB) representation for the non-CMYK deposition material; and using the RGB representation cause the display to display the embellishment on the defined area of the image.

Clause 10: A system comprising a processor and a computer-readable medium containing programming instructions, wherein the programming instructions are configured to cause the processor to implement a method according to any of clauses 1-9.

Clause 11: The system of clause 10, further comprising one or more print devices.

Clause 12: The system of clause 10 or 11, further comprising a display device.

Clause 13: A computer-readable medium containing programming instructions, wherein the programming instructions are configured to cause the processor to implement a method according to any of clauses 1-9.

1. A system for printing a document with an embellishment, the system comprising:
a processor; and
a memory containing programming instructions that are configured to cause the processor to:
identify an image to be applied to a substrate using cyan, magenta, yellow, and/or black (CMYK) inks to form a printed document;
cause a display to output the image;
in response to input from a user, define an area of the image to which an embellishment will be added, wherein the embellishment comprises a design to be applied to the printed document using a non-CMYK deposition material; and
in response to a user input, generate one or more print files containing information that is configured to cause one or more print devices to print the document by affixing the image to the substrate using one or more of the CMYK inks and affixing the embellishment to the substrate using the non-CMYK deposition material.

2. The system of claim 1, further comprising the one or more print devices, and wherein each of the one or more print devices includes a controller and programming instructions that are configured to cause that print device to print at least a portion of the document by, upon processing one or more of the print files:
using the one or more CMYK inks to affix the image to the substrate; and
using the non-CMYK deposition material to affix the embellishment to the substrate.

3. The system of claim 2, wherein:
the one or more print devices comprise a single print device having one or more CMYK ink stations and the non-CMYK deposition material;
the instructions to generate the one or more print files comprise instructions to generate a single print file with a first layer containing information that is configured to cause the single print device to print the image and a mask layer containing information that is configured to cause the single print device to print the embellishment;
the information that is configured to cause the one or more print devices to use the one or more CMYK inks is in the first layer; and
the information that is configured to cause the one or more print devices to use the non-CMYK deposition material is in the mask layer.

4. The system of claim 2, wherein the instructions to generate the one or more print files comprise instructions to, in response to not confirming that a single print device having one or more CMYK ink stations and the non-CMYK deposition material will be available:
generate a first print file containing information that is configured to cause a first print device having one or more CMYK ink stations to print the image on the substrate; and
generate a second print file with information that is configured to cause a second print device to affix the non-CMYK deposition material to the substrate.

5. The system of claim 1, wherein the programming instructions are further configured to cause the processor to, in further response to the user input, cause the display to update the image to output an enhanced image in which a representation of the embellishment is displayed in the defined area according to one or more selected specifications.

6. The system of claim 5, further comprising instructions to:
before causing the display to output the enhanced image, output one or more candidate specifications for the embellishment by:
sending the image or the area to an image classifier to return a class,
identifying one or more specifications that correspond to the class, and
outputting the identified one or more specifications as the one or more candidate specifications; and
wherein the one or more selected specifications were selected by the user from the one or more candidate specifications.

7. The system of claim 1, further comprising instructions to, in response to the user input being a text string:
process the text string to identify one or more keywords in the text string;
use the one or more keywords to search a set of embellishment specifications and return one or more embellishment specifications that correspond to the one or more keywords; and
output the returned one or more embellishment specifications as one or more candidate specifications,
wherein the returned one or more embellishment specifications were selected by the user from the one or more candidate specifications.

8. The system of claim 1, further comprising instructions to, in response to the user input being a text string:
input the text string or one or more keywords from a text string to a trained artificial intelligence model; and
upon receiving one or more embellishment specifications from the model in response to the input, output the received one or more embellishment specifications as one or more candidate specifications;
wherein the received one or more embellishment specifications were selected by the user from the one or more candidate specifications.

9. The system of claim 1, wherein the instructions to cause the display to output the image comprise instructions to:
identify a red, green, blue (RGB) representation for the non-CMYK deposition material; and
use the RGB representation cause the display to display the embellishment on the defined area of the image.

10. A method for printing a document with an embellishment, the method comprising, by a processor:
identifying an image to be applied to a substrate using cyan, magenta, yellow, and/or black (CMYK) inks to form a printed document;
causing a display to output the image;
in response to input from a user, defining an area of the image to which an embellishment will be added, wherein the embellishment comprises a design to be applied to the printed document using a non-CMYK deposition material; and
generating one or more print files containing information that is configured to cause one or more print devices to print the document by affixing the image to the substrate using one or more of the CMYK inks and affixing the embellishment to the substrate using the non-CMYK deposition material.

11. The method of claim 10, further comprising, by the one or more print devices upon processing one or more of the print files:
using the one or more CMYK inks to affix the image to the substrate; and
using the non-CMYK deposition material to affix the embellishment to the substrate.

12. The method of claim 11, wherein:
the one or more print devices comprise a single print device having one or more CMYK ink stations and the non-CMYK deposition material;
generating the one or more print files comprises generating a single print file with a first layer containing information that is configured to cause the single print device to print the image and a mask layer containing information that is configured to cause the single print device to print the embellishment;
the information that is configured to cause the one or more print devices to use the one or more CMYK inks is in the first layer; and
the information that is configured to one or more print devices to use the non-CMYK deposition material is in the mask layer.

13. The method of claim 11, wherein generating the one or more print files comprises, in response to not confirming that a single print device having one or more CMYK ink stations and the non-CMYK deposition material will be available:
generating a first print file containing information that is configured to cause a first print device having one or more CMYK ink stations to print the image on the substrate; and
generating a second print file with information that is configured to cause a second print device to affix the non-CMYK deposition material to the substrate.

14. The method of claim 10 further comprising, in further response to the user input, causing the display to update the image to output an enhanced image in which a representation of the embellishment is displayed in the defined area according to the one or more specifications.

15. The method of claim 14, further comprising:
before causing the display to output the enhanced image, causing the display to output one or more candidate specifications for the embellishment by:
sending the image or the area to an image classifier to return a class,
identifying one or more specifications that correspond to the class, and
outputting the identified one or more specifications as the one or more candidate specifications; and
wherein the one or more selected specifications are selected by the user from the one or more candidate specifications.

16. The method of claim 10 further comprising, in response to the user input being a text string:
processing the text string to identify one or more keywords in the text string;
using the one or more keywords to search a set of embellishment specifications and return one or more embellishment specifications that correspond to the one or more keywords; and
outputting the returned one or more embellishment specifications as one or more candidate specifications,
wherein the one or more selected specifications are selected by the user from the one or more candidate specifications.

17. The method of claim 10 further comprising, in response to the user input being a text string:
inputting the text string or one or more keywords from a text string to a trained artificial intelligence model; and
upon receiving one or more embellishment specifications from the model in response to the input, outputting the received one or more embellishment specifications as one or more candidate specifications,
wherein the received one or more embellishment specifications are selected by the user from the one or more candidate specifications.

18. The method of claim 10, wherein causing the display to output the image comprises:
identifying a red, green, blue (RGB) representation for the non-CMYK deposition material; and
using the RGB representation cause the display to display the embellishment on the defined area of the image.

19. A computer program product comprising a memory containing programming instructions that are configured to cause a processor to:
identify an image to be applied to a substrate using cyan, magenta, yellow, and/or black (CMYK) inks to form a printed document;
cause a display to output the image;
in response to input from a user, define an area of the image to which an embellishment will be added, wherein the embellishment comprises a design to be applied to the printed document using a non-CMYK deposition material; and
in response to a user input, generate one or more print files containing information that is configured to cause one or more print devices to print the document by affixing the image to the substrate using one or more of the CMYK inks and affixing the embellishment to the substrate using the non-CMYK deposition material.

20. The computer program product of claim 19, further comprising additional programming instructions that are configured to cause the one or more print devices to print at least a portion of the document by, upon processing one or more of the print files:
using the one or more CMYK inks to affix the image to the substrate; and
using the non-CMYK deposition material to affix the embellishment to the substrate.
